(19) United States
(12) Patent Application Publication
(10) Pub. No.: US 2012/0327540 A1
(43) Pub. Date: Dec. 27, 2012

(54) BASE STATION RADIO FREQUENCY SYSTEM AND METHOD FOR PROTECTING RADIO FREQUENCY POWER AMPLIFIER

(75) Inventors: Jianli Liu, Shenzhen City (CN); Huazhang Chen, Shenzhen City (CN); Xiaojun Cui, Shenzhen City (CN)

(73) Assignee: ZTE CORPORATION, Shenzhen City, Guangdong (CN)

(21) Appl. No.: 13/513,377

(22) PCT Filed: Oct. 27, 2011
(86) PCT No.: PCT/CN11/81427

§ 371 Date: Jun. 1, 2012

(30) Foreign Application Priority Data
Apr. 29, 2011 (CN) 201110110874.9

(51) Int. Cl. H02H 9/00

(52) U.S. Cl. 361/54

(57) ABSTRACT

A method is disclosed for protecting a radio frequency power amplifier applied in a base station radio frequency system. The method comprises: a protection detection circuit detecting a signal output by a transceiver and sending a turn-on control signal to a protection switch circuit when the signal is greater than a preset threshold; and the protection switch circuit receiving the turn-on control signal sent by the protection detection circuit and controlling its grounded connection based on the turn-on control signal. A base station radio frequency system is also disclosed comprising a transceiver and a radio frequency power amplifier connected to each other, a protection detection circuit and a protection switch circuit. Using the method and system, abnormal big signals with wide spectrum cannot enter the power amplifier, thereby achieving the object of protecting the power amplifier from being damaged.

### TECHNICAL FIELD

The present invention relates to the field of communication technologies, and more particularly, to a base station radio frequency system and a method for protecting a radio frequency power amplifier.

### BACKGROUND OF THE RELATED ART

In a wireless communication system, a radio frequency power amplifier (power amplifier for short), which is one of core modules of the entire base station equipment system, amplifies baseband and downlink radio frequency signals output by a transceiver to a certain radio frequency power level for transmission via antennas, to achieve complete coverage, thereby ensuring unimpeded communication throughout a cell.

Data analysis shows that in the whole base station, power consumption of a power amplifier occupies about 60% of total power consumption, and the radio frequency power amplifier is the most energy-consuming component in the base station system and at the same time is a component with the harshest working environment (the largest power and highest temperature) in the whole base station. Therefore, ensuring good reliability of the radio frequency power amplifier so as not to damage it under various system environment conditions is a necessary condition of a mature product and also one of difficulties faced by numerous designers of power amplifiers.

In current wireless communication base station systems, in order to ensure linearity of power amplifiers and improve efficiency of the power amplifiers, the digital pre-distortion (DPD) technology is applied in the downlink.

Currently, for various reasons, a transceiver may output abnormal big signals with wide spectrum in power-up, initialization, operation, reset and power-down stages of a base station system. Such signals may cause a power amplifier to enter into an overload state instantly if input into the power amplifier, thus burn out a power amplifier device.

One of solutions to the problem that abnormal big signals with wide spectrum cause breakdown of power amplifiers is to avoid output of the abnormal big signals with wide spectrum using a complex method in a digital circuit. Because of various reasons of generating abnormal signals in the system and a wide range of locations where the abnormal signals are generated, it is impossible to completely avoid output of the abnormal big signals with wide spectrum.

### CONTENT OF THE INVENTION

The present invention provides a base station radio frequency system and a method for protecting a radio frequency power amplifier so as to solve the existing problem that abnormal big signals with wide spectrum breakdown a power amplifier tube when input into the power amplifier.

The present invention provides a base station radio frequency system comprising a transceiver and a radio frequency power amplifier connected to each other, a protection detection circuit and a protection switch circuit, wherein

the protection detection circuit connected between the transceiver and the radio frequency power amplifier is configured to detect a signal output by the transceiver and send a turn-on control signal to the protection switch circuit when the signal is greater than a preset threshold; and

the protection switch circuit connected between the protection detection circuit and the radio frequency power amplifier is configured to receive the turn-on control signal sent by the protection detection circuit and control its grounded connection based on the turn-on control signal.

In the system in accordance with the present invention,

the protection detection circuit is further configured to send a turn-off control signal to the protection switch circuit when the signal is less than or equal to the preset threshold; and

the protection switch circuit is further configured to receive the turn-off control signal sent by the protection detection circuit and control its ungrounded connection based on the turn-off control signal.

In the system in accordance with the present invention,

the protection detection circuit comprises a coupler, an amplifier, a first diode, a first output, and a second output; wherein

the coupler is configured to sample the signal output by the transceiver, output the sampled signal to the amplifier, and output the signal output by the transceiver via the first output;

the amplifier is configured to amplify the signal sampled by the coupler to a preset value; and

the first diode is configured to demodulate the signal amplified by the amplifier and output a direct current voltage to the protection switch circuit via the second output.

In the system in accordance with the present invention,

the protection switch circuit comprises a first transistor, a second transistor, a second diode and a third output, wherein

a positive terminal of the second transistor is connected to the first output and a negative terminal of the second transistor is connected to a ground terminal, a base of the first transistor is connected to the second output of the protection detection circuit, a base of the second transistor is connected to a collector of the first transistor, and the base of the second transistor is connected to the negative terminal of the second diode, and a collector of the second transistor is connected to the third output; and

the first transistor and the second transistor receive the direct current voltage output by the second output and are turned on when the direct current voltage is greater than a threshold voltage; and the second transistor is grounded when both the first transistor and the second transistor are turned on.

The present invention also provides a method for protecting a radio frequency power amplifier applied in a base radio frequency system comprising:

a protection detection circuit detecting a signal output by a transceiver and sending a turn-on control signal to a protection switch circuit when the signal is greater than a preset threshold; and

the protection switch circuit receiving the turn-on control signal sent by the protection detection circuit and controlling its grounded connection based on the turn-on control signal.

The method further comprises:

the protection detection circuit sending a turn-off control signal to the protection switch circuit when the signal is less than or equal to the preset threshold; and

the protection switch circuit receiving the turn-off control signal sent by the protection detection circuit and controlling its ungrounded connection based on the turn-off control signal.

In the method in accordance with the present invention,

the protection detection circuit comprises a coupler, an amplifier, a first diode, a first output, and a second output; wherein

the step of the protection detection circuit detecting the signal output by the transceiver and sending the turn-on control signal to the protection switch circuit when the signal is greater than the preset threshold comprises:

the coupler sampling the signal output by the transceiver, outputting the sampled signal to the amplifier, and outputting the signal output by the transceiver via the first output;

the amplifier amplifying the signal sampled by the coupler to a preset value; and

the first diode demodulating the signal amplified by the amplifier and outputting a direct current voltage to the protection switch circuit via the second output.

In the method in accordance with the present invention,

the protection switch circuit comprises a first transistor, a second transistor, a second diode and a third output, wherein

a positive terminal of the second transistor is connected to the first output and a negative terminal of the second transistor is connected to a ground terminal, a base of the first transistor is connected to the second output of the protection detection circuit, a base of the second transistor is connected to a collector of the first transistor, and the base of the second transistor is connected to the negative terminal of the second diode, and a collector of the second transistor is connected to the third output; and

in the step of the protection switch circuit receiving the turn-on control signal sent by the protection detection circuit and controlling its grounded connection based on the turn-on control signal,

the first transistor and the second transistor receives the direct current voltage output by the second output and are turned on when the direct current voltage is greater than a threshold voltage; and the second transistor is grounded when both the first transistor and the second transistor are turned on.

Using the base station radio frequency system and the method for protecting the radio frequency power amplifier described above, abnormal big signals with wide spectrum cannot enter the power amplifier, thereby achieving the object of protecting the power amplifier from being damaged.

### BRIEF DESCRIPTION OF DRAWINGS

FIG. 1 is a block diagram of a base station radio frequency system according to an embodiment of the present invention;

FIG. 2 is a structural schematic diagram of PD and PS circuits according to an embodiment of the present invention; and

FIG. 3 is a flowchart of a method for protecting a power amplifier according to a embodiment of the present invention.

### PREFERRED EMBODIMENTS OF THE PRESENT INVENTION

In order to make objects, technical schemes and advantages of the present invention more clear and apparent, embodiments of the present invention will be described in detail in conjunction with the accompanying drawings. It should be noted that the embodiments of the present application and features in the embodiments can be combined randomly in the case of no conflict.

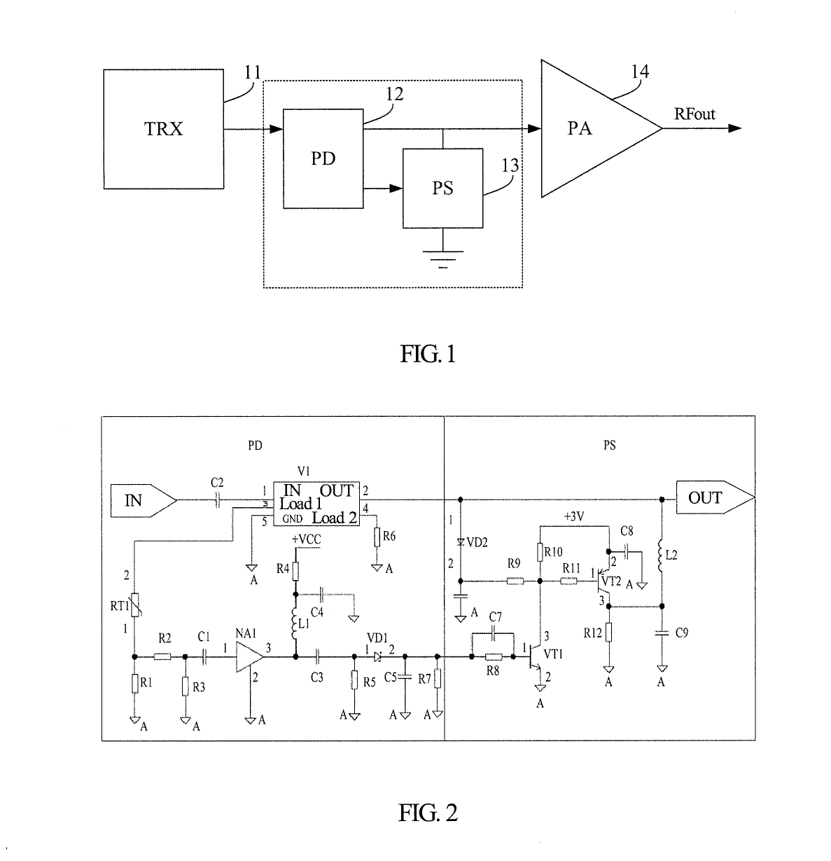

As shown in FIG. 1, a block diagram of a base station radio frequency system according to an embodiment of the present invention is provided. The system comprises a transceiver (TRX) 11, a protection detection circuit (PD) 12, a protection switch circuit (PS) 13 and a power amplifier (PA) 14. In the figure, RFout represents an output port of radio frequency signals. The protection detection circuit connected between the transceiver and the radio frequency power amplifier is configured to detect a signal output by the transceiver and send a turn-on control signal to the protection switch circuit when the signal is greater than a preset threshold. The protection switch circuit connected between the protection detection circuit and the radio frequency power amplifier is configured to receive the turn-on control signal sent by the protection detection circuit and control its grounded connection based on the turn-on control signal.

In the base station radio frequency system, a protection detection circuit and a protection switch circuit are added at an input port of the power amplifier. Normally, the protection switch circuit is ungrounded. When the transceiver outputs abnormal big signals with wide spectrum for various reasons, the protection detection circuit detects signal anomaly, controls turn-on of the protection switch circuit, makes short circuit of the abnormal big signals to ground, prevents the abnormal big signals from being input into the power amplifier, thereby avoiding breakdown of the power amplifier. When the signals are recovered to normal, the protection switch circuit is turned off again and the system is restored to work normally.

The base station radio frequency system described above has advantages of simple structure, small occupation area, low costs and high reliability, and it effectively protects the power amplifier and greatly reduces the possibility of damage of the power amplifier during system test, production, aging and external field application, improving the reliability of the system.

The PD and PS circuits in the base station radio frequency system shown in FIG. 1 can be implemented in a variety of ways, as shown in FIG. 2, a structural schematic diagram of the PD and PS circuits is provided.

The protection detection circuit comprises a coupler, an amplifier, a first diode, a first output, and a second output. The coupler is configured to sample the signal output by the transceiver, output the sampled signal to the amplifier, and output the signal output by the transceiver via the first output. The amplifier is configured to amplify the signal sampled by the coupler to a preset value. The first diode is configured to demodulate the signal amplified by the amplifier and output a direct current voltage to the protection switch circuit via the second output.

The protection switch circuit comprises a first transistor, a second transistor, a second diode and a third output. A positive terminal of the second transistor is connected to the first output and a negative terminal of the second transistor is connected to a ground terminal; a base of the first transistor is connected to the second output of the protection detection circuit; a base of the second transistor is connected to a collector of the first transistor, and the base of the second transistor is connected to the negative terminal of the second diode, and a collector of the second transistor is connected to the third output. The first transistor and the second transistor receive the direct current voltage output by the second output and are turned on when the direct current voltage is greater than a threshold voltage; and the second transistor is turned on to ground when both the first transistor and the second transistor are turned on.

Specifically, the coupler U1 samples the signal output by the transceiver, the amplifier NA1 amplifies the sampled signal to a desired level (the value of which may be preset as required), and the diode VD1 demodulates the amplified sample signal and outputs a direct current voltage. The diode VD2 is a radio frequency switch (which is turned on when a forward voltage is applied across the switch and is turned off when a reverse voltage is applied across the switch). When the signal output by the TRX is greater than a preset threshold, a direct current voltage output by VD1 turns on the transistors VT1 and VT2 (i.e. the direct current voltage output by VD1 is greater than threshold voltages of the two transistors such that the two transistors can be turned on), the forward voltage is applied across VD2 and the radio frequency switch is grounded, thereby protecting the power amplifier from burnout by big signals; when the signal output by the TRX is less than the preset threshold, the direct current voltage output by VD1 turns off the transistors VT1 and VT2, the radio frequency switch is ungrounded, and the signal is input into the power amplifier.

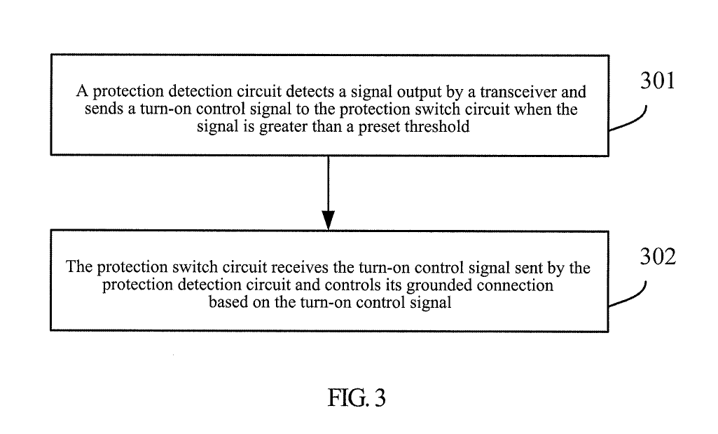

As shown in FIG. 3, a flowchart of a method for protecting a power amplifier according to an embodiment of the present invention is provided. The method is applied in the system shown in FIG. 1 and comprises the following steps.

In step 301, a protection detection circuit detects a signal output by a transceiver and sends a turn-on control signal to a protection switch circuit when the signal is greater than a preset threshold.

The preset threshold can be dynamically adjusted as required.

In step 302, the protection switch circuit receives the turn-on control signal sent by the protection detection circuit and controls its grounded connection based on the turn-on control signal.

Furthermore, the method can further comprise the protection detection circuit sending a turn-off control signal to the protection switch circuit when the signal is less than or equal to the preset threshold and the protection switch circuit receiving the turn-off control signal sent by the protection detection circuit and controls its ungrounded connection based the turn-off control signal.

Preferably, the protection detection circuit may comprise a coupler, an amplifier, a first diode, a first output, and a second output. Referring to FIG. 2 specifically, in the step of the protection detection circuit detecting the signal output by the transceiver and sending the turn-on control signal to the protection switch circuit when the signal is greater than the preset threshold, the coupler samples the signal output by the transceiver, outputs the sampled signal to the amplifier, and outputs the signal output by the transceiver via the first output; the amplifier amplifies the signal sampled by the coupler to a preset value; and the first diode demodulates the signal amplified by the amplifier and outputs a direct current voltage to the protection switch circuit via the second output.

Preferably, the protection switch circuit may comprise a first transistor, a second transistor, a second diode and a third output. A positive terminal of the second transistor is connected to the first output and a negative terminal of the second transistor is connected to a ground terminal, a base of the first transistor is connected to the second output of the protection detection circuit, a base of the second transistor is connected to a collector of the first transistor, and the base of the second transistor is connected to the negative terminal of the second diode, and a collector of the second transistor is connected to the third output.

In the step of the protection switch circuit receiving the turn-on control signal sent by the protection detection circuit and controlling its grounded connection based on the turn-on control signal, the first transistor and the second transistor receives the direct current voltage output by the second output and are turned on when the direct current voltage is greater than a threshold voltage, and the second transistor is grounded when both the first transistor and the second transistor are turned on.

The method can be applied in the base station radio frequency system, when the transceiver outputs abnormal big signals with wide spectrum for various reasons, the protection detection circuit detects signal anomaly, controls turn-on of the protection switch circuit, makes short circuit of the abnormal big signals to ground, prevents the abnormal big signals from being input into the power amplifier, thereby avoiding burnout of the power amplifier.

It may be understood by those skilled in the art that all or some of the steps in the described method can be implemented by related hardware instructed by programs which may be stored in computer readable storage mediums, such as read-only memory, disk or CD-ROM, etc. Alternatively, all or some of the steps in the embodiments described above may also be implemented using one or more integrated circuits. Accordingly, each module/unit in the embodiments described above may be implemented in a form of hardware, or software functional module. The present invention is not limited to combinations of hardware and software in any particular form.

The embodiments described above are merely used for describing the technical scheme of the present invention and is not intended to limit the present invention. The present invention is described in detail only with reference to preferred embodiments. Various modifications or equivalent substitutions to the present invention may be made by those skilled in the art without departing from the spirit and scope of the technical scheme of the present invention. Such modifications and substitutions should be covered in the scope of the appended claims of the present invention.

### INDUSTRIAL APPLICABILITY

Using the present invention, abnormal big signals with wide spectrum cannot enter the power amplifier, thereby achieving the object of protecting the power amplifier from being damaged.

What we claim is:

1. A base station radio frequency system comprising a transceiver and a radio frequency power amplifier connected to each other, a protection detection circuit and a protection switch circuit, wherein
the protection detection circuit connected between the transceiver and the radio frequency power amplifier is configured to detect a signal output by the transceiver and send a turn-on control signal to the protection switch circuit when the signal is greater than a preset threshold; and
the protection switch circuit connected between the protection detection circuit and the radio frequency power amplifier is configured to receive the turn-on control signal sent by the protection detection circuit and control its grounded connection based on the turn-on control signal.

2. The system according to claim 1, wherein
the protection detection circuit is further configured to send a turn-off control signal to the protection switch circuit when the signal is less than or equal to the preset threshold; and
the protection switch circuit is further configured to receive the turn-off control signal sent by the protection detection circuit and control its ungrounded connection based on the turn-off control signal.

3. The system according to claim 2, wherein
the protection detection circuit comprises a coupler, an amplifier, a first diode, a first output, and a second output; wherein
the coupler is configured to sample the signal output by the transceiver, output the sampled signal to the amplifier, and output the signal output by the transceiver via the first output;
the amplifier is configured to amplify the signal sampled by the coupler to a preset value; and
the first diode is configured to demodulate the signal amplified by the amplifier and output a direct current voltage to the protection switch circuit via the second output.

4. The system according to claim 3, wherein
the protection switch circuit comprises a first transistor, a second transistor, a second diode and a third output, and wherein
a positive terminal of the second transistor is connected to the first output and a negative terminal of the second transistor is connected to a ground terminal, a base of the first transistor is connected to the second output of the protection detection circuit, a base of the second transistor is connected to a collector of the first transistor, and the base of the second transistor is connected to the negative terminal of the second diode, and a collector of the second transistor is connected to the third output; and
the first transistor and the second transistor receive the direct current voltage output by the second output and are turned on when the direct current voltage is greater than a threshold voltage; and the second transistor is grounded when both the first transistor and the second transistor are turned on.

5. A method for protecting a radio frequency power amplifier applied in a base radio frequency system comprising:
a protection detection circuit detecting a signal output by a transceiver and sending a turn-on control signal to a protection switch circuit when the signal is greater than a preset threshold; and
the protection switch circuit receiving the turn-on control signal sent by the protection detection circuit and controlling its grounded connection based on the turn-on control signal.

6. The method according to claim 5, further comprising:
the protection detection circuit sending a turn-off control signal to the protection switch circuit when the signal is less than or equal to the preset threshold; and
the protection switch circuit receiving the turn-off control signal sent by the protection detection circuit and controlling its ungrounded connection based on the turn-off control signal.

7. The method according to claim 5, wherein
the protection detection circuit comprises a coupler, an amplifier, a first diode, a first output, and a second output, and wherein
the step of the protection detection circuit detecting the signal output by the transceiver and sending the turn-on control signal to the protection switch circuit when the signal is greater than the preset threshold comprises:
the coupler sampling the signal output by the transceiver, outputting the sampled signal to the amplifier, and outputting the signal output by the transceiver via the first output;
the amplifier amplifying the signal sampled by the coupler to a preset value; and
the first diode demodulating the signal amplified by the amplifier and outputting a direct current voltage to the protection switch circuit via the second output.

8. The method according to claim 7, wherein
the protection switch circuit comprises a first transistor, a second transistor, a second diode and a third output, and wherein
a positive terminal of the second transistor is connected to the first output and a negative terminal of the second transistor is connected to a ground terminal, a base of the first transistor is connected to the second output of the protection detection circuit, a base of the second transistor is connected to a collector of the first transistor, and the base of the second transistor is connected to the negative terminal of the second diode, and a collector of the second transistor is connected to the third output; and
in the step of the protection switch circuit receiving the turn-on control signal sent by the protection detection circuit and controlling its grounded connection based on the turn-on control signal,
the first transistor and the second transistor receives the direct current voltage output by the second output and are turned on when the direct current voltage is greater than a threshold voltage; and the second transistor is grounded when both the first transistor and the second transistor are turned on.
